(19) United States
(12) Patent Application Publication
(10) Pub. No.: US 2007/0058705 A1
(43) Pub. Date: Mar. 15, 2007

(54) System and method to transmit a data stream

(75) Inventors: Jin Wang, Walnut Creek, CA (US); Richard Dennis Hart, Concord, CA (US); Raghvendra G. Savoor, Walnut Creek, CA (US)

Correspondence Address: TOLER SCHAFFER, LLP, 5000 PLAZA ON THE LAKES, SUITE 265, AUSTIN, TX, 78746, US

(73) Assignee: SBC Knowledge Ventures, L.P., Reno, NV (US)

(21) Appl. No.: 11/225,858

(22) Filed: Sep. 13, 2005

(51) Int. Cl. H04L 5/16

(52) U.S. Cl. 375/222

(57) ABSTRACT

The present disclosure is directed to a method and system of transmitting data. The method includes providing a data signal and providing at least one redundant data signal. The method also includes transmitting a data stream, wherein the data signal and the at least one redundant data signal are combined to regenerate the data stream. The method can include transmitting the data signal and the at least one redundant data signal via a plurality of twisted pairs.

### FIELD OF THE DISCLOSURE

The present disclosure relates generally to transmitting data using signals.

### BACKGROUND

The transmission of voice and data information is integral to most business and home environments. Communicating data across networks, such as the Internet, has greatly increased the efficiency of acquiring and using such data. Many individuals and businesses require faster data transmission than that provided by dial-up services. Various new technologies, including cable, T-1 lines, and digital subscriber line (DSL) services, provide high-speed alternatives for data transmission.

Unlike cable service providers, DSL providers can use conventional phone lines to transmit information. Unfortunately, DSL and similar services can be limited by the technical capacities of conventional phone lines and related equipment. For example, signals may not be transmitted beyond certain distances. These maximum loop lengths force service providers to build new infrastructure, such as additional central offices and remote terminals, to serve many communities and to compete with other data transmission services that do not have such technical limitations. Additionally, the use of conventional phone lines may produce noise and signal reflections that reduce communication quality and disturb users.

### BRIEF DESCRIPTION OF THE DRAWINGS

FIG. 1 is a block diagram illustrating an embodiment of a data transmission system;

FIG. 2 is a block diagram illustrating a second embodiment of a data transmission system;

FIG. 3 is a flow diagram illustrating a method of receiving data;

FIG. 4 is a flow diagram illustrating a method of transmitting data; and

FIG. 5 is a diagram of one embodiment of a general computer system.

### DETAILED DESCRIPTION OF THE DRAWINGS

A data transmission system is disclosed and includes a destination modem device that receives a data signal and at least one redundant data signal from a source modem device. The destination modem device combines the data signal and each redundant data signal to yield a data stream transmitted by the source modem device. In a particular embodiment, the destination modem device can be a digital subscriber line transceiver.

In a particular embodiment, a plurality of twisted pairs can be coupled to the destination modem device. The plurality of twisted pairs can further include a first twisted pair and at least one additional twisted pair. In this particular embodiment, the destination modem device receives the data signal via the first twisted pair, and the destination modem device receives each redundant data signal via an additional twisted pair. In a particular embodiment, each twisted pair may be a twisted wire pair. For example, each twisted pair could be a twisted pair of copper wires. In another particular embodiment, each twisted pair could be a coaxial cable.

In another particular embodiment, the source modem device can include a first line driver and at least one additional line driver. The first line driver can transmit the data signal to the destination modem device, via the first twisted pair. Each additional line driver transmits a redundant data signal to the destination modem device, via an additional twisted pair. In another particular embodiment, the destination modem device can include a first line receiver, and at least one additional line receiver. The first line receiver can receive the data signal from the first line driver, via the first twisted pair. Each additional line receiver can receive a redundant data signal from an additional line driver, via an additional twisted pair.

In a particular embodiment, the system may include a summation device coupled to the destination modem device that combines the data signal and each redundant data signal. Further, the system can also include at least one phase adjustment device. For example, each phase adjustment device can be electrically coupled to the destination modem device. Each phase adjustment device can adjust at least one redundant data signal into phase with the data signal. In an illustrative embodiment, each phase adjustment device can be a variable delay circuit.

In another embodiment, a method of transmitting data is disclosed and includes providing a data signal and providing at least one redundant data signal. The method also includes transmitting an output data stream, wherein the data signal and each redundant data signal are combined to regenerate the data stream.

In yet another embodiment, a method of receiving data is provided and includes receiving a data signal and receiving at least one redundant data signal. The method also includes receiving a data stream, wherein the data signal and each redundant data signal are combined to regenerate the data stream.

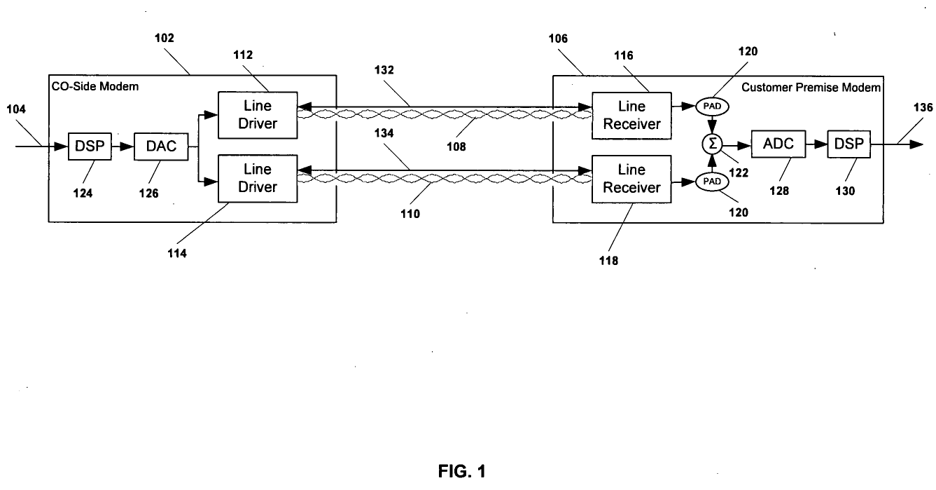

Referring to FIG. 1, a data transmission system is shown and is generally designated 100. As shown, the system 100 includes a source modem device 102 that receives a data stream 104. The source modem device 102 is coupled to a destination modem 106, via a first twisted pair 108 and at least one additional twisted pair 110. In an illustrative embodiment, a twisted pair can be a twisted wire pair, such as a twisted copper wire pair. In another illustrative embodiment, a twisted pair can be a coaxial cable.

The source modem device 102 transmits a data signal 132 and at least one redundant data signal 134 to the destination modem device 106. The source modem device 102 communicates the data signal 132 to the destination modem device 106 via the first twisted pair 108. Further, the source modem device 102 can communicate each redundant data signal 134 to the destination modem device 106 via the additional twisted pair 110. The destination modem device 106 combines the data signal 132 and each redundant data signal 134 to produce a data stream in a combined signal 136.

In an illustrative embodiment, the source modem device 102 can be a digital subscriber line (DSL) modem, and the destination modem device 106 can be a DSL transceiver. For example, the source modem device 102 can be a central office-side modem of a DSL service provider, and the destination modem device 106 can be a DSL transceiver at a customer premise.

In a particular embodiment, as depicted in FIG. 1, the source modem device 102 can include a first line driver 112 and at least one additional line driver 114. In this particular embodiment, the first line driver 112 transmits the data signal 132 to the destination modem device 106 via the first twisted pair 108. Further, each additional line driver 114 transmits a redundant data signal 134 to the destination modem device 106 via an additional twisted pair 110.

In an illustrative embodiment, the source modem device 102 can include a digital signal processing (DSP) device 124. For example, the DSP device 124 can be a chip that conducts Fast-Fourier-Transform (FFT). In this embodiment, the source modem device 102 can also include a digital-to-analog converter (DAC) 126 that converts a digital signal out of DSP block into an analog signal that is suitable for transmission on telephone pair.

As further illustrated in FIG. 1, the destination modem device 106 can include a first line receiver 116 and at least one additional line receiver 118. In this particular embodiment, the first line receiver 116 receives the data signal 132 from the source modem device 102 via the first twisted pair 108. Further, each additional line receiver 118 receives a redundant data signal 134 from the source modem device. 102 via an additional twisted pair 110.

In an illustrative embodiment, the destination modem device 106 can include an analog-to-digital converter (ADC) 128 that converts an analog signal that is suitable for transmission on telephone pair into a digital signal that is fed into a DSP device 130. For example, the DSP device 124 can be a chip that conducts Inverse Fast-Fourier-Transform (IFFT).

FIG. 1 illustrates that the system can also include one or more phase adjustment devices (PADs) 120. In a particular embodiment, each phase adjustment device 120 can be integrated with the destination modem device 106, prior to signal summation. For example, a phase adjustment device 120 can be placed in the path from each additional line receiver 118 to a summation device 122. In an illustrative embodiment, each phase adjustment device 120 can be a variable delay circuit that is adjusted during the training cycle of the modem initiated by a power-on sequence. Each phase adjustment device 120 can adjust a redundant data signal 134 that is received by the destination modem device 106 into phase with the data signal 132 that is received by the destination modem device 106. The data signals may be out of phase due to differences in the lengths of the first twisted pair 108 and one or more of the additional twisted pairs 110. The phase delay is measured and an adjustment is made to compensate for the out-of-phase condition.

In a particular embodiment, the destination modem device 106 can include the summation device 122 coupled to the destination modem device 106. In a particular embodiment, as depicted in FIG. 1, the summation device 122 is coupled to each line receiver 118. The summation device 122 can combine the data signal 132 with each redundant data signal 134, thereby producing a summed signal 136. The destination modem device 106 can communicate the combined signal 136 to one or more destination devices at the customer premises.

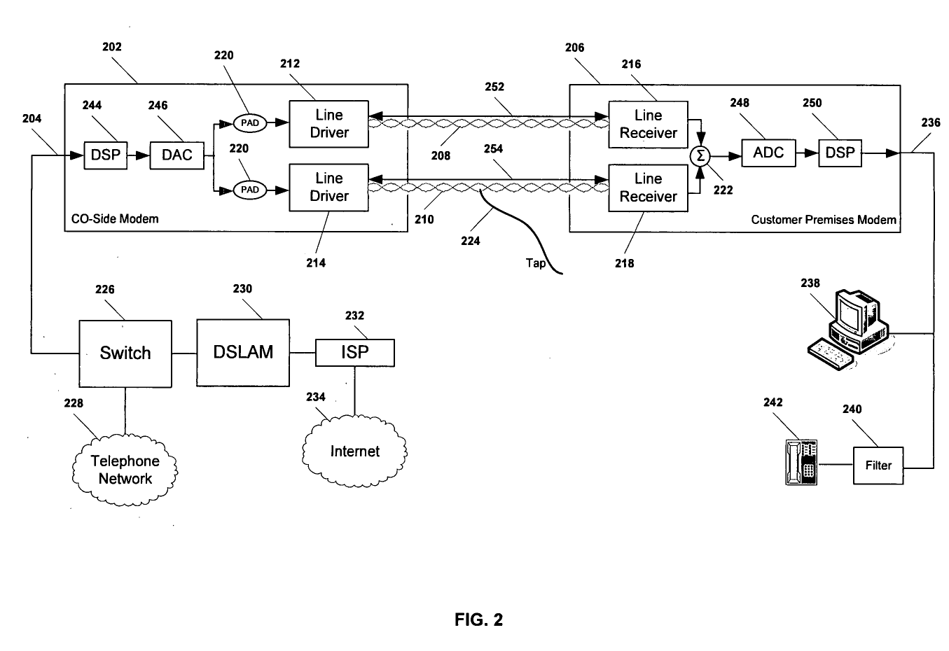

Referring to FIG. 2, a data transmission system is shown and is generally designated 200. As shown, the system 200 includes a source modem device 202. In an illustrative embodiment, the source modem device 202 can be a digital subscriber line (DSL) modem. For example, the source modem device 202 can be a central office-side modem of a DSL service provider coupled to a switch 226. Further, the switch 226 can be coupled to a digital subscriber line access multiplexer (DSLAM) 230. Moreover, the switch 226 can be coupled to an Internet service provider (ISP) 232 that communicates with the Internet 234. The switch can also communicate with a telephone network 228, such as a public switched telephone network, a cellular network, a mobile phone network, or a voice-over Internet protocol network. The switch 226 can combine the data that it receives from the telephone network 228 and the Internet 234, via the ISP 232 and the DSLAM 230, into a data stream 204. The switch then transmits the data stream 204 to the source modem device 202.

As shown in FIG. 2, the source modem device 202 is coupled to a destination modem device 206. In a particular embodiment, as depicted in FIG. 2, the source modem device 202 is coupled to a destination modem device 206 via a first twisted pair 208 and at least one additional twisted pair 210.

The source modem device 202 transmits a data signal 252 and at least one redundant data signal 254 to the destination modem device 206. The source modem device 202 communicates the data signal 252 to the destination modem device 206 via the first twisted pair 208. Further, the source modem device 202 can communicate each redundant data signal 254 to the destination modem device 206 via an additional twisted pair 210. The destination modem device 206 combines the data signal 252 and each redundant data signal 254 to yield the data stream in a combined signal 236.

In a particular embodiment, as depicted in FIG. 2, the source modem device 202 can include a first line driver 212 and at least one additional line driver 214. In this particular embodiment, the first line driver 212 transmits the data signal 252 to the destination modem device 206 via the first twisted pair 208. Further, each additional line driver 214 transmits a redundant data signal 254 to the destination modem device 206 via an additional twisted pair 210.

As further illustrated in FIG. 2, the destination modem device 206 can include a first line receiver 216 and at least one additional line receiver 218. In this particular embodiment, the first line receiver 216 receives the data signal 252 from the source modem device 202 via the first twisted pair 208. Further, each additional line receiver 218 receives a redundant data signal 254 from the source modem device 202 via an additional twisted pair 210.

FIG. 2 illustrates that the system can also include one or more phase adjustment devices (PADs) 220. In the particular embodiment shown by FIG. 2, each phase adjustment device 220 can be integrated with the source modem device 206, prior to signal transmission. For example, a phase adjustment device 220 can be coupled to each additional line driver 214. In an illustrative embodiment, each phase adjustment device 220 can be a variable delay circuit. Each phase adjustment device 220 can adjust a redundant data signal that is sent by the source modem device 202 into phase with the data signal that is sent by the source modem device 202, where the adjustment compensates for differences in the lengths of the first twisted pair 208 and one or more of the additional twisted pairs 210.

In a particular embodiment, the destination modem device 206 can include a summation device 222. In a particular embodiment, as depicted in FIG. 2, the summation device 222 is coupled to each line receiver 218. The summation device 222 can combine the data signal 252 with each redundant data signal 254, thereby producing a summed signal 236. The destination modem device 206 can communicate the summed signal 236 to one or more destination devices at the customer premises. In an illustrative embodiment, the destination modem device 206 can be a DSL transceiver at a customer premises.

In a particular embodiment, the summed signal 236 can be either an addition or subtraction, depending on if the source modem device 202 reverses the polarity of the redundant signal 254. For example, when the source modem device 202 does reverse the polarity of the redundant signal 254, the summation device 222 of the destination modem device 204 produces the difference of the data signal 252 and the redundant data signal 254, instead of their sum.

As shown in FIG. 2, the destination modem device can communicate the summed signal 236 to one or more destination devices. The summed signal produces a data stream that is equivalent or similar to the data stream 204, at one or more of the destination devices. For example, the destination modem device 206 can communicate a summed signal 236 to a computing device 238, such as a personal computer, a laptop computer, and the like. In another example, the destination modem device 206 can communicate the summed signal 236 to a telephony device 242. The destination modem device 206 can pass the summed signal 236 to the telephony device 242, through a filter 240, such as a low-pass filter.

In a particular embodiment, the system can include a bridged tap 224. For example, a bridged tap 224 can connect a central office main line to multiple lateral lines that connect to multiple customer premises. In an illustrative embodiment, as shown in FIG. 2, a bridged tap 224 can be coupled to an additional twisted pair 210.

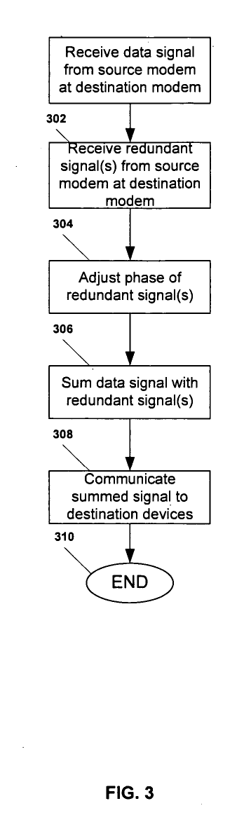

Referring to FIG. 3, a method of receiving data is shown. At block 300, a data signal is received. At block 302, at least one redundant data signal is received. In an illustrative embodiment, the redundant data signal can be substantially similar to the data signal or it can be an inverse of the data signal. In a particular embodiment, the data signal can be received from a source modem at a destination modem. For example, the source modem device can be a central office digital subscriber line (DSL) modem of a DSL service provider, and the destination modem device can be a DSL transceiver at a customer premises. For purposes of describing the method, blocks 300 and 302 are shown in succession. Nonetheless, such succession does not indicate that the data signal and redundant data signals must be received in any particular sequence.

In a particular embodiment, the method can include receiving the data signal via a first twisted pair, and receiving each redundant signal via an additional twisted pair.

Moving to block 304, the method can also include adjusting the phase of one or more redundant data signals, such that each redundant data signal is in phase with the received data signal. The phase may be adjusted using a phase adjustment device. In a particular embodiment, each phase adjustment device can be integrated with the destination modem device, prior to signal summation. In an illustrative embodiment, each phase adjustment device can be a variable delay circuit.

As shown at block 306, the method can also include summing the data signal with each redundant data signal, producing a summed signal. In a particular embodiment, the summed signal can be either an addition or subtraction, depending on whether the polarity of the redundant signal has been reversed. For example, when the source modem device reverses the polarity of the redundant signal, the summed signal can be the difference of the data signal and the redundant data signal, instead of their sum.

Moving to block 308, the summed signal can be communicated to one or more destination devices. For example, the method can include communicating the summed signal to a computing device and/or a telephony device, to provide the data stream. The method then terminates at 310.

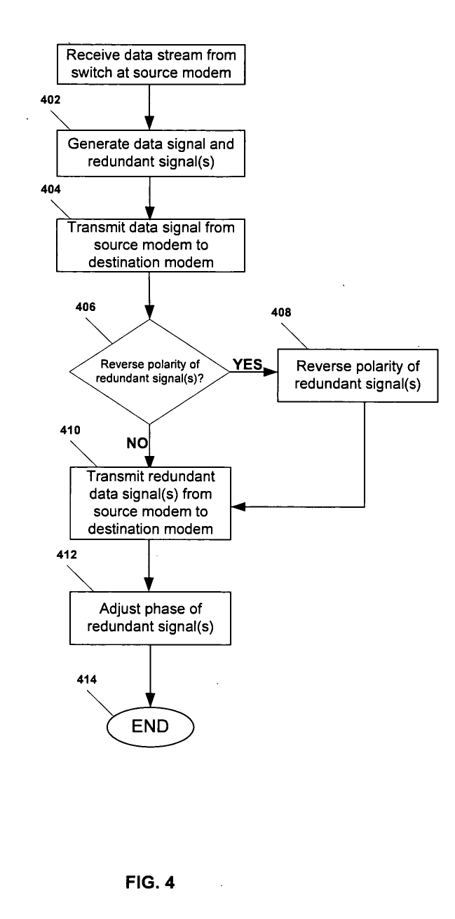

Referring to FIG. 4, an embodiment of a method of transmitting data is shown. At block 400, a data stream to be transmitted can be received at a source modem device from a network switch. At block 402, the source modem device generates a data signal and at least one redundant data signal. The data signal and the redundant data signal(s) each represent the data stream. In an illustrative embodiment, the redundant data signal can be substantially similar to the data signal or it can be an inverse of the data signal.

At block 404, the data signal is transmitted from the source modem to a destination modem. In a particular embodiment, the method can include transmitting the data signal via a first twisted pair.

As shown at decision step 406, the method can also include determining whether to reverse the polarity of one or more redundant data signals. For example, the first twisted pair and at least one additional twisted pair are often adjacent in the same binder. Most noise sources, such as AM radio, neighboring DSL circuits, and impulse noise sources, introduce similar interference into adjacent pairs. Thus, noise on the adjacent twisted pairs can be highly correlated. If so, the source modem can determine that the transmit polarity of the redundant signal on the additional twisted pair should be reversed. After such reversal, and after the destination modem device combines the received two signals by subtracting one from the other, the signal power will be increased, while the noise on the adjacent twisted pairs is reduced. In an illustrative embodiment, modems implementing this embodiment of the method can measure the performance of DSL service when each redundant signal has one polarity, and compare the measured performance with the performance of DSL using the opposite polarity, thereby determining the preferred polarity scheme for the data signal and each redundant data signal.

Moving to block 406, when it is determined that the polarity of one or more redundant data signals should be reversed, the polarity of the redundant data signal(s) is reversed, at 408. The redundant data signal(s) are then transmitted, as shown at block 410. When it is determined that the polarity of one or more redundant data signal(s) should not be reversed, the method proceeds directly to block 410, and the redundant data signal(s) are transmitted. In a particular embodiment, the method can include transmitting each redundant data signal via an additional twisted pair, as described herein.

Moving to block 412, the method can also include adjusting the phase of one or more redundant data signals, such that each redundant data signal is in phase with the data signal when they arrive at a destination modem device. The phase may be adjusted using a phase adjustment device. The phase adjustment device(s) may be coupled to the source modem device, as described herein, such that one or more redundant data signals are brought into phase with the data signal, before they are transmitted. In an illustrative embodiment, a phase adjustment device can be a variable delay circuit. The method then terminates at 414.

In a particular embodiment, the steps of the methods described herein are executed in the order shown by the figures. In alternative embodiments, the steps may be executed in alternative sequences. For example, in the method shown by FIG. 4, a preferred polarity scheme for DSL service may be determined by the source modem device at any time before the redundant data signal(s) are transmitted. This may include determining a polarity scheme before a certain data stream is received from the switch, before the data signal and redundant data signals are generated, and before the data signal is transmitted.

In conjunction with the configuration of structure described herein, the system and method disclosed provides overall increases in signal strength over conventional telephone lines, without increasing noise to the same extent. Thus, signal strength can be increased over equal loop lengths, and maximum loop lengths can be increased for signals of conventional strengths. In the DSL context, such effects improve DSL performance and reach by mitigating the impacts of line noise, impulse noise, and bridged-tap issues, while requiring minor alterations on modem design and being fully compatible with all existing DSL standards. The methods can both improve signal levels and decrease noise levels for overall improvement in the Signal-to-Noise ratio of the transmission system. These effects are particularly advantageous, for example, on troublesome asymmetric digital subscriber line (ADSL) circuits of long loop lengths or very high speed digital subscriber line (VDSL) circuits, particularly on circuits restricted in performance by decreased signal strength due to one or more bridged taps.

Bridged taps cause loop loss to exhibit notches periodically in frequency. As a bridged taps get shorter, the notches become deeper. The existence of such notches (10-20 dB deep) can seriously harm DSL transmission. Multiple twisted pair transmission reduces the depth of the notches by compensating the excess loss on one pair with the normal loss on another. For instance, FIG. 2 shows a first twisted pair that has no bridged tap, and an additional twisted pair that has a short tap. If the tap causes a 20 dB notch, a loss analysis indicates that the combined loss between the first twisted pair and the additional twisted pair will be about a 6 dB notch instead of a 20 dB notch. Even if the first twisted pair has a bridged tap as well, the combined loss will still be about a 6 dB notch if the taps on the two pairs have different lengths.

The system and method disclosed combine DSL signals in analog domain, whereas the conventional “wire bonding” techniques combine bit streams out of DSP chips. Thus, the traditional wire bonding use two DSL modems and combine the two distinct bit streams out of each modem into one bit stream.

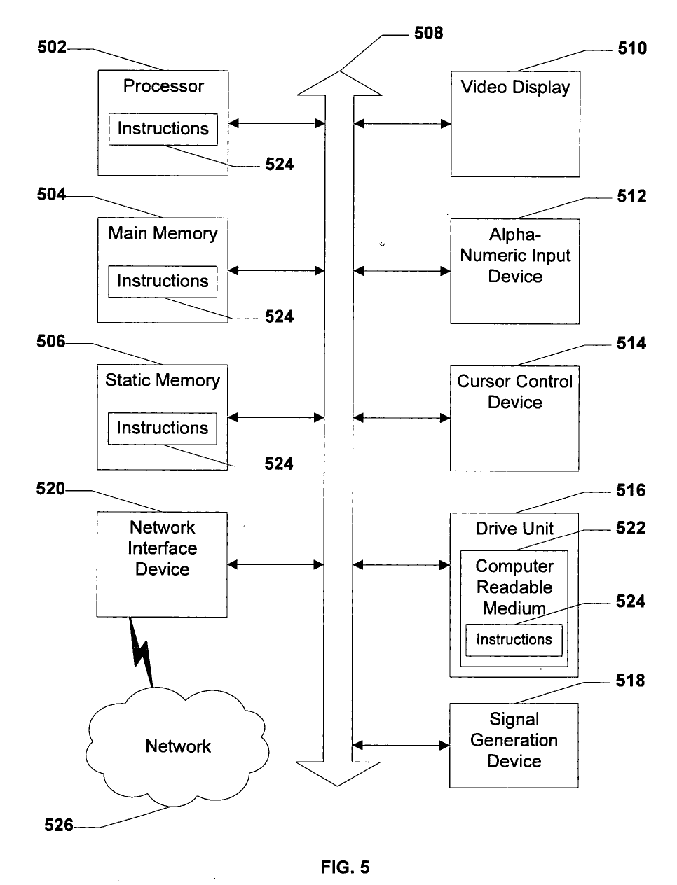

Referring to FIG. 5, an illustrative embodiment of a general computer system is shown and is designated 500. The computer system 500 can include a set of instructions that can be executed to cause the computer system 500 to perform any one or more of the methods or computer based functions disclosed herein. The computer system 500, or a portion thereof, may operate as a standalone device or may be connected, e.g., using a network, to other computer systems or peripheral devices, or may be embedded in a DSL modem.

In a networked deployment, the computer system may operate in the capacity of a server or as a client user computer in a server-client user network environment, or as a peer computer system in a peer-to-peer (or distributed) network environment. The computer system 500 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 500 can be implemented using electronic devices that provide voice, video or data communication. Further, while a single computer system 500 is illustrated, the term “system” shall also be taken to include any collection of systems or sub-systems that individually or jointly execute a set, or multiple sets, of instructions to perform one or more computer functions.

As illustrated in FIG. 5, the computer system 500 may include a processor 502, e.g., a central processing unit (CPU), a graphics processing unit (GPU), or both. Moreover, the computer system 500 can include a main memory 504 and a static memory 506 that can communicate with each other via a bus 508. As shown, the computer system 500 may further include a video display unit 510, such as a liquid crystal display (LCD), an organic light emitting diode (OLED), a flat panel display, a solid state display, or a cathode ray tube (CRT). Additionally, the computer system 500 may include an input device 512, such as a keyboard, and a cursor control device 514, such as a mouse. The computer system 500 can also include a disk drive unit 516, a signal generation device 518, such as a speaker or remote control, and a network interface device 520.

In a particular embodiment, as depicted in FIG. 5, the disk drive unit 516 may include a computer-readable medium 522 in which one or more sets of instructions 524, e.g. software, can be embedded. Further, the instructions 524 may embody one or more of the methods or logic as described herein. In a particular embodiment, the instructions 524 may reside completely, or at least partially, within the main memory 504, the static memory 506, and/or within the processor 502 during execution by the computer system 500. The main memory 504 and the processor 502 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 524 or receives and executes instructions 524 responsive to a propagated signal, so that a device connected to a network 526 can communicate voice, video or data over the network 526. Further, the instructions 524 may be transmitted or received over the network 526 via the network interface device 520.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

In accordance with various embodiments, the methods described herein may be implemented as one or more software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that software that implements the disclosed methods may optionally be stored on a tangible storage medium, such as: a magnetic medium, such as a disk or tape; a magneto-optical or optical medium, such as a disk; or a solid state medium, such as a memory card or other package that houses one or more read-only (non-volatile) memories, random access memories, or other re-writable (volatile) memories. The software may also utilize a signal containing computer instructions. A digital file attachment to e-mail or other self-contained information archive or set of archives is considered a distribution medium equivalent to a tangible storage medium. Accordingly, the disclosure is considered to include a tangible storage medium or distribution medium as listed herein, and other equivalents and successor media, in which the software implementations herein may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A data communication system, the system comprising:
a source modem device;
wherein the source modem device receives an initial data stream from at least one network;
wherein the source modem communicates a data signal and at least one redundant data signal to a destination modem device; and
wherein the data signal and the at least one redundant data signal are combinable to produce a combined data stream that is substantially the same as the initial data stream.

2. The system of claim 1, wherein the at least one redundant data signal is substantially the same as the data signal.

3. The system of claim 1, wherein the at least one redundant data signal is a phase shifted version of the data signal.

4. The system of claim 1, wherein the at least one redundant data signal is an inverse of the data signal.

5. The system of claim 1, further comprising a plurality of twisted pairs coupled to the source modem device;
wherein the plurality of twisted pairs further comprises a first twisted pair and at least one additional twisted pair;
wherein the source modem device transmits the data signal via the first twisted pair; and
wherein the source modem device transmits the at least one redundant data signal via the at least one additional twisted pair.

6. The system of claim 5, wherein the data signal is communicated over a coaxial cable.

7. The system of claim 5, wherein at least one bridged tap is coupled to at least one of the plurality of twisted pairs.

8. The system of claim 1, further comprising at least one phase adjustment device coupled to the source modem device.

9. The system of claim 8, wherein the at least one phase adjustment device further comprises at least one variable delay circuit.

10. The system of claim 2:
wherein the source modem device further comprises a first line driver and at least one additional line driver;
wherein the first line driver transmits the data signal via a first twisted pair; and
wherein the at least one additional line driver transmits the redundant data signal via at least one additional twisted pair.

11. The system of claim 1, wherein the source modem device further comprises a digital subscriber line modem.

12. A data communication system, the system comprising:
a destination modem device;
wherein the destination modem device receives a data signal and at least one redundant data signal from a source modem device; and
wherein the destination modem combines the data signal and the at least one redundant data signal to produce a combined data stream that is substantially the same as an initial data stream received by the source modem.

13. The system of claim 12, further compromising at least one phase adjustment device coupled to the destination modem device.

14. The system of claim 12, further comprising a summation device coupled to the destination modem device.

15. The system of claim 12:
wherein the destination modem device further comprises a first line receiver and at least one additional line receiver;
wherein the first line receiver receives the data signal from a first line driver, via a first twisted pair; and
wherein the at least one additional line receiver receives the redundant data signal from at least one additional line driver, via at least one additional twisted pair.

16. The system of claim 12, wherein the destination modem device further comprises a digital subscriber line transceiver.

17. A method of transmitting data, the method comprising:
providing a data signal;
providing at least one redundant data signal; and
transmitting an output data stream, wherein the data signal and the at least one redundant data signal are combined to regenerate the output data stream.

18. The method of claim 17, further comprising transmitting the data signal and the at least one redundant data signal from a source modem device.

19. The method of claim 18, further comprising transmitting the data signal via a first twisted pair and transmitting the at least one redundant data signal via at least one additional twisted pair.

20. The method of claim 18, further comprising:
receiving a data stream at the source modem device from at least one network, via at least one switch; and
generating the data signal and the at least one redundant data signal based on the received data stream.

21. The method of claim 20, further comprising receiving the data stream from the at least one network via a digital subscriber line access multiplexer, wherein the digital subscriber line access multiplexer is coupled to the at least one switch.

22. The method of claim 20, further comprising receiving the data stream from at least one telephone network, wherein the telephone network is coupled to the at least one switch.

23. The method of claim 22, wherein the at least one telephone network comprises at least one network selected from a group consisting of a public switched telephone network, a cellular network, a voice-over internet protocol network, and a mobile phone network.

24. The method of claim 17, further comprising transmitting the data signal via a first line driver, and transmitting the at least one redundant data signal via at least one additional line driver.

25. The method of claim 18, further comprising adjusting a phase of the at least one redundant data signal with respect to the data signal, prior to transmitting the output data stream.

26. The method of claim 19, wherein the first twisted pair has a first polarity and the at least one additional twisted pair has a second polarity, and further comprising reversing the second polarity, such that the second polarity is opposite to the first polarity.

27. A method of receiving data, the method comprising:
receiving a data signal via a first twisted pair;
receiving at least one redundant data signal via at least one additional twisted pair; and
combining the data signal and the at least one redundant data signal to produce a data stream.

28. The method of claim 27, further comprising receiving the data signal and the at least one redundant data signal at a modem device.

29. The method of claim 28, further comprising adjusting the at least one redundant data signal into phase with the data signal at the destination modem device.

30. The method of claim 27, further comprising summing the at least one redundant data signal with the data signal, wherein the data signal and the at least one redundant data signal are combined to produce a summed signal.

31. The method of claim 30, further comprising communicating the summed signal to at least one destination device.

32. The method of claim 31, further comprising communicating the summed signal to a computing device.

33. The method of claim 31, further comprising communicating the summed signal to a telephony device.

34. A computer program embedded within a computer-readable medium, the computer program comprising:
instructions to receive a data stream at a source modem device from at least one network;
instructions to generate a data signal and at least one redundant data signal based on the received data stream; and
instructions to transmit an output data stream, wherein the data signal and the at least one redundant data signal are combined to produce the data stream.

35. A computer program embedded within a computer-readable medium, the computer program comprising:
instructions to receive a data signal at a destination modem device via a first twisted pair;
instructions to receive at least one redundant data signal at the destination modem device via at least one additional twisted pair; and
instructions to combine the data signal and the at least one redundant data signal to produce a combined data stream.
